(19) United States
(12) Patent Application Publication
(10) Pub. No.: US 2007/0297848 A1
(43) Pub. Date: Dec. 27, 2007

(54) Document-Filling Notebook

(75) Inventor: Christophe Pierre Antoine Marie Girard, Douvres La Delivrande (FR)

Correspondence Address: LEYDIG VOIT & MAYER, LTD, 700 THIRTEENTH ST. NW, SUITE 300, WASHINGTON, DC, 20005-3960, US

(73) Assignee: PAPETERIES HAMELIN, Caen (FR)

(21) Appl. No.: 10/598,837

(22) PCT Filed: Mar. 14, 2005
(86) PCT No.: PCT/FR05/00603

§ 371 Date: Jul. 2, 2007

(30) Foreign Application Priority Data
Mar. 16, 2004 (FR) 0402705

(51) Int. Cl. B42F 13/00

(52) U.S. Cl. 402/60

(57) ABSTRACT

A document-filing notebook includes inner sheets which are indexed with tabs and which are inseparably connected to the binder, such that the pages of the notebook can be filed separately from the binder.

This invention relates to a document-filing notebook.

The increasing frequency of daily and/or weekly meetings leads to an increasing number of notes being taken on notebook pages or loose sheets of paper. The problem then arises of periodically filing these documents in an orderly fashion, according to each type of meeting having taken place during the day.

This invention proposes a notebook that enables documents to be immediately filed or sorted at the end of each meeting,

For this purpose, the document-filing notebook of the invention, comprising a cover consisting of two front and back leaves assembled together by a binder, and inner notebook pages connected to the binder between the two leaves, is characterized in that the notebook pages are detachable, and in that it includes inner index sheets with tabs that are inseparably connected to the binder and that make it possible to file notebook pages separated from the binder, and/or other external notebook pages or documents, in the various compartments created by the inner separation sheets.

Preferably, each notebook page includes a scored line that is parallel to the binder in proximity to it, and along which the notebook page can be detached, in order to file it in a compartment between two adjacent inner separation sheets.

The inner separation sheets are advantageously arranged at the end of the notebook, between the pages of the notebook and its back leaf.

The tabs are arranged at different heights and are added on to the inner separation sheets or obtained by cutting out from these sheets.

According to an alternative embodiment, the front leaf has a width such that it invisibly covers up the tabs of the inner separation sheets when the notebook is in the closed position.

According to another alternative embodiment, the front leaf has a width such that it enables the tabs of the inner separation sheets to be made visible and directly accessible when the notebook is in the closed position.

The front or back leaf includes three flaps, along the upper and lower edges and the side edge of the leaf, respectively.

The notebook can be closed by at least one closing means consisting of an elastic band fastened to the front or back leaf by rivets or the like and capable of sliding relative to the leaf via two eyelets, and capable of being pulled down over one of the corners of the opposing leaf, or entirely over the latter parallel to the binder.

The closing means can also be pulled down over one of the corners of the superimposed inner separation sheets or over them entirely.

The binder can be of the spiral type.

The invention will be better understood, and other purposes, characteristics, details and advantages thereof will become more apparent, during the course of the following explanatory description provided with reference to the appended schematic drawings, given for illustrative purposes only, which show two embodiments of the invention, and in which:

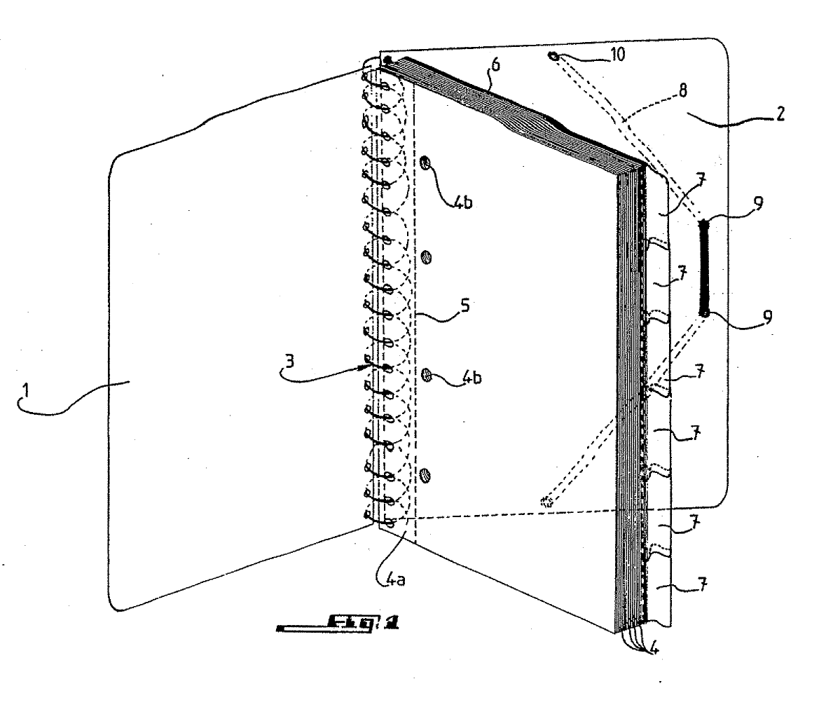

FIG. 1 is a perspective view of a filing notebook of the invention in the open position;

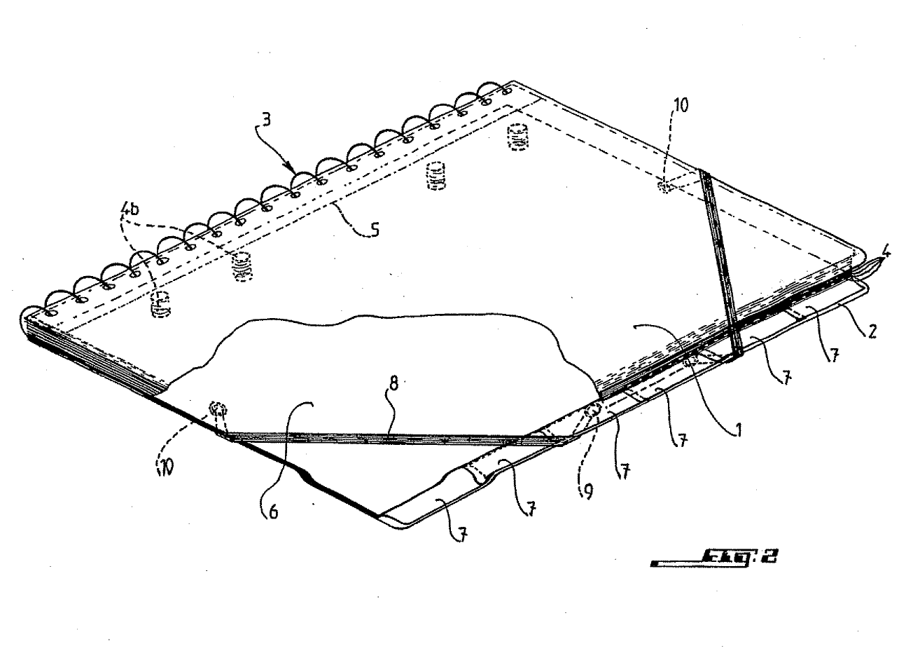

FIG. 2 is a perspective view of the filing notebook of FIG. 1 in the closed position;

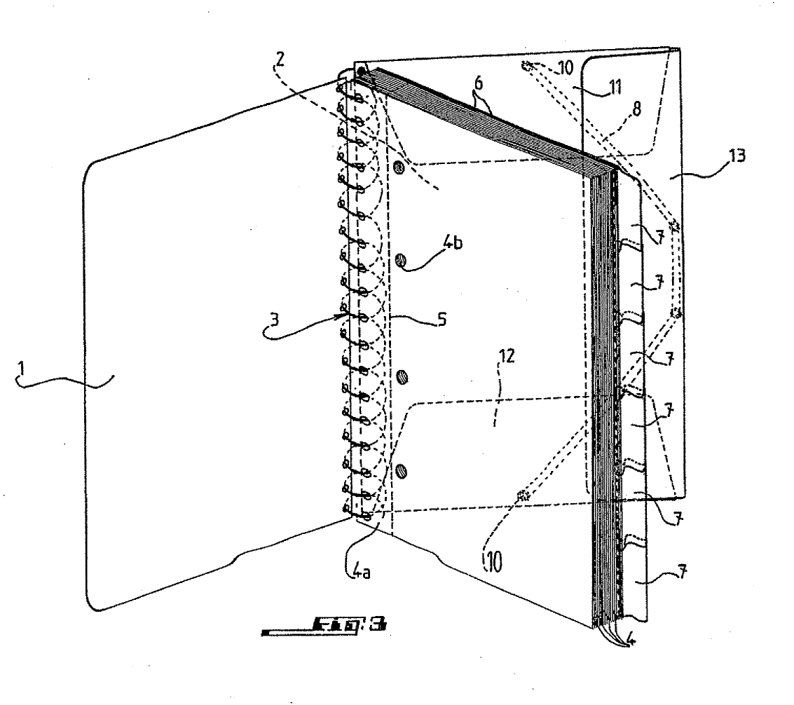

FIG. 3 is a perspective view of another embodiment of the filing notebook in the open position, and also equipped with a filing jacket; and

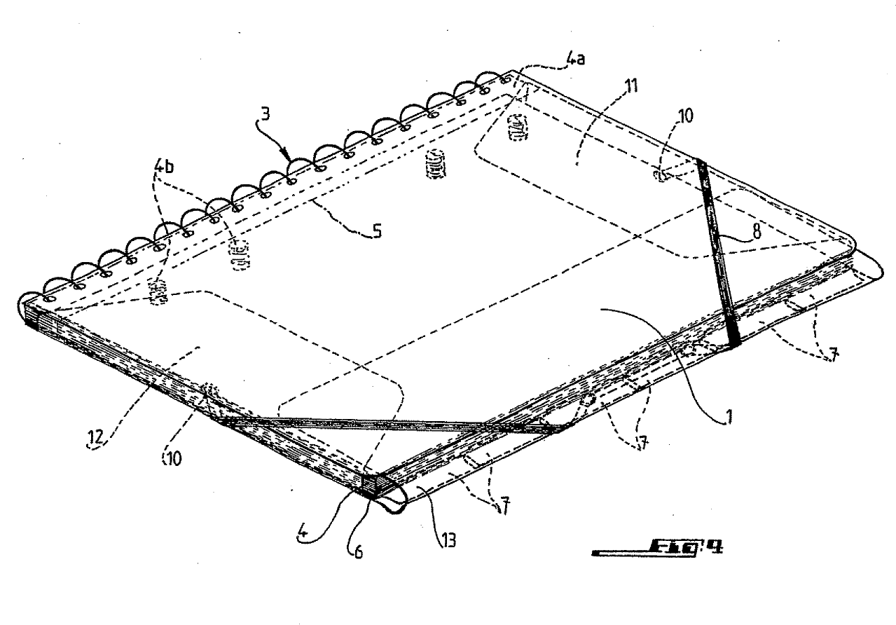

FIG. 4 is a perspective view of the notebook of FIG. 3 in the closed position.

Referring to FIGS. 1 and 2, the filing notebook includes a cover consisting of a front leaf 1, and a back leaf 2 that is connected to the front leaf 1 by a binder 3.

The notebook further includes inner pages 4, connected to the binder 3, between the leaves 1 and 2.

The front 1 and back 2 leaves can be made of cardboard or a plastic material that provides a certain degree of rigidity while at the same time being flexible.

According to the invention, the notebook pages 4 can be individually separated from the binder 3, and for this purpose each page 4 preferably comprises a scored line or tear line 5 running parallel to the binder 3 in proximity to it. In this way, when a page 4 is detached from the binder along the scored line 5, a strip of paper 4a remains held by the binder 3, which preferably consists of spirals that assemble together the leaves 1, 2 and notebook pages 4 via corresponding perforations in the leaves 1, 2 and pages 4.

The filing notebook also includes inner separation sheets 6 that are enclosed inside the cover defined by the leaves 1 and 2 and that are irremovably connected to the spiral binder 3, which passes through perforations in the inner sheets 6.

The inner sheets 6 each comprise a tab 7 located on the right-hand edge of the sheet opposite the binder 3.

The tabs 7 can be added onto the respective inner sheets 6, or can be obtained by cutting these sheets so as to be arranged at different heights, in order to create an index. These tabs can comprise inscriptions relating to headings dedicated to specific subjects dealt with during the course of one day, for example.

In this case, the filing notebook includes six inner sheets 6, and as a result, six tabs 7, which can be of different colors.

Preferably, the inner separation sheets 6 are arranged at the end of the notebook, between the notebook pages 4 and the back leaf 2, but they can be arranged between the front leaf 1 and the notebook pages 4.

The front leaf 1 of the filing notebook can have a width such that, in the closed position of the notebook shown in FIG. 2, it makes it possible to invisibly cover up the tabs 7 of the inner sheets 6, but the width of the front leaf 1 can be such that it enables these tabs to be made visible and accessible when the notebook is in closed position.

The filing notebook can be closed by a closing means which, in this case, consists of an elastic tie 8, preferably in the form of a band having a circular or rectangular cross section, which is slidably mounted on the back side of the back leaf 2 via two eyelets 9, and which is fastened at its ends to the back leaf 2 by rivets 10, for example, or by any other equivalent fastening means. In this way, in the closed position of the notebook shown in FIG. 2, the elastic band 8 can be pulled down over the two corners of the front leaf 1 in order to hold the notebook in the closed position and to consequently prevent the sheets housed between the inner sheets 6 from escaping from the notebook. FIG. 2 shows in a cut-away view that the elastic band 8 can be pulled down over each corner of the superimposed inner sheets 6, in order to hold between them the notebook pages or any other document, while at the same time allowing use of the notebook pages attached to the binder 3. Of course, the elastic band 8 can also be pulled down entirely over the front leaf 1 parallel to the binder 3, in order to hold the notebook in the closed position.

The elastic band 8 fastening means can be fastened to the front leaf 1 and pulled down over the corners of the back leaf 2 when the filing notebook is in the closed position.

The notebook of the invention makes it possible to file the notebook pages 4 on which notes have been taken, in order to group them, after having separated them from the binder 3 by tearing along the line 5, and to file them in the various compartments defined by the inner sheets 6. The user can then later remove the groups of paper filed in the compartments of the inner sheets 6 in order to permanently file them in appropriate files by using perforations 4b in the notebook 4, when applicable. Of course, the notebook can be used for filing other annotated loose pages or any other external document, such as scientific, medical or other types of periodicals, in the compartments defined between the inner separation sheets 6, whether for future meetings or as documents received at meetings.

According to the embodiment of the filing notebook shown in FIGS. 3 and 4, and whose elements identical to those of the embodiment of FIGS. 1 and 2 bear the same references, the back leaf 2 comprises three flaps 11, 12, 13 along its upper, lower and right-hand or side edges, respectively, which, when in the folded-down position on the back leaf 2, form a jacket or pocket for storing the set consisting of the notebook pages 4 connected to the binder 3 and the inner separation sheets 6, or only the inner separation sheets 6 capable of containing inside their respective compartments loose pages 4 that have been detached from the binder 3, the pad of notebook pages 4 attached to the binder 3 then being arranged on top of the flaps 11-13. Of course, the notebook pocket defined by the flaps 11-13 can be used for filing separate documents, such as scientific, medical or other types of periodicals. Accessories such as pens or a calculator can also be housed inside the pocket defined by these flaps. Alternatively, the back leaf 2 of the filing notebook can comprise only two flaps, one flap situated along the lower edge of the back leaf 2 and one flap along the side edge of this leaf.

Instead of being situated on the back leaf 2 of the filing notebook, the flaps can be arranged on the lower, upper and side edges of the front leaf 1.

Apart from the additional function of storing documents in the pocket defined by the flaps 11-13, the filing notebook of FIGS. 3 and 4 can be used in the same way as the one described with reference to FIGS. 1 and 2, the result being that it is unnecessary to describe it again in terms of its structure and function.

The filing notebook of the invention thus performs both the function of a conventional notebook and that of a document file, in particular for the notebook pages detached from the binder of the notebook, at the end of each day, enables the user to find documents filed in the compartments created by the inner separation sheets and to then permanently file them in appropriate files.

1. A filing notebook comprising:
a cover including a front leaf and a back leaf;
a binder joining the front and back leaves together;
inner notebook pages connected to the binder between the front and back leaves, wherein the notebook pages are detachable; and
inner separation sheets with tabs inseparably connected to the binder for filing notebook pages separated from the binder in respective compartments created by the inner separation sheets.

2. The filing notebook of claim 1, wherein each notebook page includes a scored line that is parallel to the binder, in proximity to the binder, and along which the notebook page can be detached in order to file the notebook page in a compartment between two adjacent inner separation sheets.

3. The filing notebook according to claim 1, wherein the inner separation sheets are located between the notebook pages of the notebook and the back leaf.

4. The filing notebook according to claim 1, wherein the tabs are located at different heights on the inner separation sheets.

5. The filing notebook according to claim 1, wherein the front leaf invisibly covers the tabs of the inner separation sheets when the notebook is closed.

6. The filing notebook according to claim 1, wherein the front leaf makes the tabs of the inner separation sheets visible and directly accessible when the notebook is closed.

7. The filing notebook according to claim 1, wherein one of the front and back leaves includes flaps along upper, lower, and side edges.

8. The filing notebook according to claim 1, including at least one closing means for keeping the notebook closed and including an elastic band fastened to one of the front and back leaves by rivets, sliding relative to the leaf via eyelets, and for pulling over a corner of the back or front leaf parallel to the binder.

9. The filing notebook of claim 8, wherein the closing means can be pulled over a corner of the inner separation sheets.

10. The filing notebook according to claim 1, wherein the binder includes a spiral.

11. The filing notebook according to claim 1, wherein the notebook pages are perforated for filing in another notebook.

12. The filing notebook according to claim 1, wherein compartments between the inner separation sheets can receive pages other than the notebook pages.

13. The filing notebook according to claim 1, including at least one closing means for keeping the notebook closed and including an elastic band fastened to one of the front and back leaves by rivets, sliding relative to the leaf via eyelets, and for pulling over the front or back leaf and parallel to the binder.

14. The filing notebook of claim 8, wherein the closing means can be pulled entirely over the inner separation sheets.

15. The filing notebook according to claim 4, wherein the front leaf invisibly covers the tabs of the inner separation sheets when the notebook is closed.

16. The filing notebook according to claim 4, wherein the front leaf makes the tabs of the inner separation sheets visible and directly accessible when the notebook is closed.
